(19) United States
(12) Patent Application Publication
(10) Pub. No.: US 2025/0153983 A1
(43) Pub. Date: May 15, 2025

(54) LIFTING GEAR

(71) Applicant: LIEBHERR-WERK BIBERACH GMBH, Biberach an der Riss (DE)

(72) Inventors: Michael Altmann, Weingarten (DE); Michael Eggert, Biberach (DE); Martin Assfalg, Oggelsbeuren (DE)

(21) Appl. No.: 18/838,975

(22) PCT Filed: Jan. 24, 2023
(86) PCT No.: PCT/EP2023/051600

§ 371 Date: Aug. 15, 2024

(30) Foreign Application Priority Data
Feb. 17, 2022 (DE) 10 2022 103 758.4
May 11, 2022 (DE) 10 2022 111 813.4

(51) Int. Cl. B66D 3/04

(52) U.S. Cl. CPC B66D 3/043

(57) ABSTRACT

A lifting gear having a hoist cable, which descends in at least two strands from a tackle support, in particular a trolley, and also having a bottom block, which is reeved on the hoist cable and on which a load-bearing means is fitted. The strands of the hoist cable are at a different distance apart from one another at the bottom block than at the tackle support. Arranged between the bottom block and the tackle support is a strand-distance guide for compensating for the different strand distances at the bottom block and at the tackle support and for guiding the cable strands substantially parallel to one another on one side of the strand-distance guide and splayed apart in a V shape in relation to one another on the opposite side of the strand-distance guide.

### CROSS-REFERENCE TO RELATED APPLICATIONS

This application is a National Stage of International Application No. PCT/EP2023/051600 filed 24 Jan. 2023, which claims benefit under 35 USC § 365 of DE Application Nos. 10 2022 103 758.4 filed 17 Feb. 2022 and 10 2022 111 813.4, filed 11 May 2022, each of which is incorporated herein by reference in its entirety as if set forth herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### SEQUENCE LISTING

Not Applicable STATEMENT REGARDING PRIOR DISCLOSURES BY THE INVENTOR OR A JOINT INVENTOR

Not Applicable

### BACKGROUND OF THE DISCLOSURE

### 1. Field of the Invention

The present invention relates to a lifting gear, for example in the form of a crane such as a rotating tower crane, having a hoist cable which descends in at least two strands from a tackle support, in particular a trolley, and a bottom block which is reeved on the hoist cable and on which a load-bearing means of the lifting gear is fitted.

### 2. Description of Related Art

In lifting gears such as cranes, the hoist cable is usually reeved in two or more strands at the bottom block to which the load hook or another load-bearing means is fitted, so that the hoist cable runs in two or more strands from the load rigging or tackle support at the jib of the crane to the bottom block at the load hook. The tackle support can be a trolley on a rotating tower crane or possibly also on a luffing jib crane, which can be moved along the jib by means of a trolley drive in order to be able to change the outreach of the crane. In other cranes or lifting gear in general, such as elevators with rope drives, the tackle support can also be permanently mounted on the jib or a structural support of the lifting gear from which the hoist cable descends. In the case of a movable trolley, the hoist cable is usually deflected at the trolley via two deflection pulleys or deflection pulley blocks in order to guide the hoist cables further along the travel path of the trolley and to be able to move the trolley without this changing the load hook height or requiring a compensating hoist rope movement. For example, the hoist rope strands on the trolley can be redirected to the jib tip on the one hand and to the jib foot on the other, so that the trolley can be moved along the jib without generating hoist rope movements.

With permanently mounted tackle supports, for example at the jib tip of a telescopic jib crane, one hoist rope line can be attached to the tackle support or a structural support of the lifting gear in its vicinity and the other hoist rope line can be deflected to be guided to the hoist winch.

In both cases, the tackle support specifies a determined strand distance for the cable strands that extend from it and lead to the bottom block or load hook, which is usually selected so that the cable strands run parallel downwards to the load-bearing means or the bottom block. Conversely, the bottom block at the load-bearing means is usually adapted to the strand distance of the tackle support in order to have parallel cable strands. If, for example, two deflection pulleys or blocks are provided on a trolley for the cable strands, the bottom block can also be configured to have two pulleys in order to create a strand distance at the bottom block that corresponds to the strand distance at the trolley.

For certain lifting tasks or applications, however, it is desirable to reduce the strand distance at the bottom block in order to make the load-bearing means slim and to be able to lower it in confined spaces such as a shaft, for example, without the lifting cable strands or also the bottom block itself causing collisions due to the corresponding construction size. In this respect, consideration has already been given to reducing the strand distance at the bottom block as far as possible, for example by using small deflection pulleys or a single-roller design of the bottom block.

However, such a bottom block with a small strand distance only partially helps when working in confined spaces. If the tackle support or trolley from which the hoist rope runs to the hook block If the tackle support or the trolley from which the hoist cable descends to the bottom block has a normal, quite large strand distance, for example due to the corresponding spacing of the deflection pulleys, the strands of the hoist cable no longer run parallel from the bottom block upwards to the tackle support, but with a spreading out in a V-shaped manner, so that when lowering into deep, narrow shafts, for example, the spreading out in a V-shaped manner again results in a relatively large strand distance, which can cause collisions at the top edge of the shaft. In order to avoid this problem of V-shaped strand spreading, consideration has already been given to replacing the tackle support for such special applications and, for example, mounting a trolley on the jib that has a similarly narrow strand distance as a single-roller or single-axle bottom block. However, such a conversion of the trolley depending on the bottom block used is quite complex and only possible with corresponding downtimes of the lifting gear.

From the patent documents DE 28 45 874 A1 and DE 81 36 572 U1, lifting gears in the form of cranes are known whose lifting gear having a hoist cable descends in multiple strands from a trolley and is reeved at the bottom block with a load hook. In this respect, the hoist cable can be run in either two or four strands by either attaching an additional deflection pulley to the trolley or leaving it detached from the trolley at the load hook or bottom block. In this respect, however, the problem with both previously known solutions is that the strand distance at the bottom block is quite large and, accordingly, the bottom block itself is also quite wide, making it difficult to work in confined surroundings.

It is therefore the underlying object of the invention to provide an improved lifting gear of the type specified, which avoids the disadvantages of the prior art and develops the latter in an advantageous manner. Preferably, it should be possible to use different bottom blocks with different strand widths without modifying the tackle support. In particular, a bottom block with small strand distances should be possible in order to enable collision-free working in narrow working spaces without having to convert the trolley or the tackle support of the lifting gear.

### BRIEF SUMMARY OF THE INVENTION

According to the invention, the task is solved by a lifting gear having a hoist cable, which descends in at least two strands from a tackle support, in particular a trolley, and also having a bottom block, which is reeved on the hoist cable and on which a load-bearing means is fitted, characterized in that the cable strands of the hoist cable are at a different distance apart from one another at the bottom block than at the tackle support, wherein between the bottom block and the tackle support there is provided a strand-distance guide for compensating for the different strand distances at the bottom block and at the tackle support and for guiding the cable strands substantially parallel to one another on one side of the strand-distance guide and splayed apart in a V shape in relation to one another on the opposite side of the strand-distance guide.

According to one aspect of the invention, it is therefore proposed to allow different strand distances at the bottom block and tackle support, but to correct these as far as possible from the bottom block upwards by means of an additional cable guide or a spacer in order to maintain a sufficiently small or, if necessary, also sufficiently large strand distance in the working area of the bottom block and the lifting cable strands located above it in order to avoid collisions of the cable strands with the working environment and to keep the lifting cable strands in the desired alignment.

According to the invention, the cable strands at the bottom block, on the one hand, and at the tackle support, on the other hand, have different strand distances, wherein a strand-distance guide is provided between the bottom block and the tackle support for compensating for the different strand distances at the bottom block and the tackle support and for guiding the cable strands substantially parallel to one another on one side of the strand-distance guide. On the other side of the strand-distance guide, the cable strands can be spread out or converge in a V-shape in order to compensate for the different strand distances at the tackle support and at the bottom block. The strand-distance guide thus limits the spreading out of the cable strands in a V-shaped manner to only a fraction of the lowering depth of the bottom block or a fraction of the distance of the bottom block from the tackle support, so that substantially parallel lifting cable strands can be used for the remaining distance despite the different strand distances at the tackle support and bottom block.

In particular, the strand-distance guide can significantly reduce the strand distance at the bottom block compared to the strand distance at the tackle support, in order to be able to work with the bottom block also in narrow working environments such as shafts or the like without having to mount a special trolley or a special tackle support at the jib of the crane or the support structure of the lifting gear. The strand-distance guide can hold the cable strands together at a strand distance that substantially corresponds to the strand distance at the bottom block, so that the spreading out of the cable strands in a V-shaped manner only occurs above the strand-distance guide at the tackle support.

In principle, however, it would also be possible to use the strand-distance guide to keep the cable strands at a greater strand distance apart, for example if a trolley with a small or narrow strand distance is mounted on the crane and a bottom block with a large strand distance is required for a special task, for example in order to be able to fit special additional equipment at the bottom block.

Depending on the desired strand-distance guide, the strand-distance guide can be used closer to the tackle support or closer to the bottom block, wherein the location of the strand-distance guide is advantageously selected such that the cable strands are guided approximately parallel over more than half or more than three quarters of the lowering depth of the bottom block, as seen from the tackle support.

In particular, the strand-distance guide can be positioned close to the tackle support in order, on the one hand, not to obstruct the height adjustment path of the bottom block and, on the other hand, to maintain the strand distance specified by the bottom block over substantially the total lowering depth of the bottom block or to guide the cable strands from the bottom block to the top at least approximately parallel.

In particular, the arrangement of the strand-distance guide directly under the tackle support or in the vicinity of the tackle support or also directly at the tackle support can be particularly advantageous if the strand distance at the bottom block is smaller than at the tackle support and the cable-distance guide holds the cable strands together substantially at the strand distance at the bottom block, so that the spreading out of the strands in a V-shaped manner only occurs in a very small section of the path, namely between the cable-distance guide and the tackle support.

In a further development of the invention, the strand-distance guide can be configured to be reeving-free, so that no components of the load-bearing load attached to the load-bearing means are transferred from the rope-distance guide or no lifting loads are transmitted to the tackle support via the rope-distance guide.

The hoist cable strands can run freely past the cable spacer guide in the main pulling direction of the hoist cable and only frictional or rolling forces occur in the longitudinal direction of the cable or in the main direction of extension of the hoist cable, i. e. in an approximately vertical direction. The main forces that are transmitted from the strand-distance guide to the hoist cable strands or, conversely, from the hoist cable strands to the strand-distance guide are substantially horizontal or transversely to the main direction of extension of the hoist cable or transversely to a straight line connecting the bottom block to the tackle support. As a rule, the main direction of extension, as specified, of the hoist cable is vertical. However, if possible pendulum movements of the load hook are taken into account, the hoist cable can also be deflected at a slight angle to the vertical, so that in this case the transverse forces transmitted by the strand-distance guide still act mainly in the horizontal direction, but can also have a small vertical component.

In a further development of the invention, the strand-distance guide can be suspended in an oscillating manner from the tackle support or, if the tackle support is fixedly mounted, from an adjacent structural part, so that the strand-distance guide can follow oscillating movements of the load-bearing means or the hoisting cable strands and can align itself relative to the tackle support, so to speak, depending on the direction in which the hoisting cable strands extend. Such an oscillating suspension of the strand-distance guide also enables the strand-distance guide to align itself automatically when the jib of the crane at which the tackle support is arranged is luffed up or down, thus changing the alignment of the tackle support.

In particular, the cable spacer guide can be suspended in an oscillating manner from the trolley, which can be moved along the jib of a crane.

In this respect, the oscillating suspension can be multi-axis articulated, for example to compensate for the jib rocking up and down and to compensate for oscillating movements of the hoist cable transversely to the longitudinal direction of the jib. In certain cases, however, it may also be sufficient to provide a single-axis oscillating suspension, for example about an oscillating axis parallel to the luffing axis of a jib that can be luffed up and down.

In this respect, the suspension of the strand-distance guide can be configured to be lightweight in order to substantially only bear the weight of the rope spacer guide. The suspension can be significantly undersized in comparing to the loads to be lifted or the tensile forces of the hoist cable to be transmitted, as the cable spacer guide does not transmit any hoisting loads and does not form a reeving that would have to absorb a significant part of the attached load, but only keeps the hoist cable strands at a distance.

However, the strand-distance guide does not necessarily have to be suspended in an oscillating manner at the tackle support, but can also be rigidly fastened to the tackle support or, if necessary, to an adjacent structural component of the lifting gear. Rigid mounting of the strand-distance guide can be particularly useful if the strand-distance guide is arranged directly at or at the same height as the tackle support.

For example, the strand-distance guide can be arranged between two deflection pulleys of the tackle support, which deflect the double-stranded descending hoist cable, and/or approximately at the level of the deflection pulleys of the tackle support, so that the cable strands of the hoist cable can be guided substantially completely parallel to the tackle support, even if the two the deflection pulleys of the tackle support would in themselves define a greater or lesser strand distance than the bottom block.

The strand-distance guide can be detachably fastened at the tackle support so that the tackle support can be operated with either a wider or narrower strand distance. If, for example, a two-roller or two-axis bottom block with a comparatively wider strand distance is used, the strand-distance guide can be removed from the tackle support to allow the hoist cable to descend at a comparatively wider distance from the two deflection pulleys. If, on the other hand, a single-roller or single-axis bottom block is used for working in confined spaces, the strand-distance guide can be mounted on the tackle support in order to taper the strand distance at the tackle support or just below or a little below it and thus have parallel cable strands up to approximately or close to the tackle support.

According to a further aspect of the present invention, however, a V-shaped spreading of the cable strands between the bottom block and the tackle support can also be permitted, for example by the strand-distance guide being dismantled from the tackle support. According to the invention, it can be provided that the strands of the hoist cable have a different strand distance from one another at the bottom block than at the tackle support, wherein the strands of the hoist cable can take a V-shaped splayed course from the bottom block to the tackle support. In this respect, the V-shaped spread of the cable strands can in particular spread upwards from the bottom block to the tackle support, so that the strand distance at the bottom block is smaller than at the tackle support. In particular, the bottom block can be configured to be single-axis or single-roller, so that the strand distance of the bottom block substantially corresponds to the diameter of the rope deflection pulley, while on the other hand, two deflection pulleys can be provided at the tackle support, which define a distance between them that is greater than the diameter of the rope pulley at the bottom block.

If such a V-shaped spread of the hoist cable strands over a greater distance of the lowering depth is disruptive, the strand-distance guide can be mounted, for example suspended in the manner in an oscillating manner at the tackle support or fastened rigidly to the tackle support in order to taper the strand distance of the hoist cable at or a little below the tackle support to the strand distance at the bottom block.

In a further development of the invention, the strand-distance guide can have a cable yoke which engages around the at least two cable strands of the hoist cable from opposite outer sides in order to limit and/or reduce the strand distance of the cable strands, in particular to a strand distance which essentially corresponds to the strand distance specified by the bottom block, so that the cable strands run essentially parallel from the bottom block to the strand-distance guide.

The cable yoke can engage around the cable strands from at least three sides or also on all four sides in the manner of a box through which the cable strands pass. In this respect, the cable yoke can engage with the at least two cable strands on sides of the cable strands that face away from each other. If two approximately parallel cable strands are considered, these cable strands have inner sides facing towards each other and outer sides facing away from each other, wherein the cable yoke can contact the outer sides facing away from each other in order to prevent the cable strands from running too far apart and occupying a strand distance that would be too large.

In a further development of the invention, the strand-distance guide, in particular the cable yoke, can have two cable guide elements lying opposite one another, between which the cable strands to be guided at a distance pass, wherein the portions of the cable guide elements facing one another can limit a clear width between them which corresponds to the desired strand distance. In particular, the sides of the cable guide elements facing each other can have a distance from each other which substantially corresponds to the distance between the inlet and outlet points of the bottom block.

The cable guide elements can in particular be cable guide rollers or cable deflection rollers, which can be rotatably mounted on a carrier of the strand-distance guide, in particular the aforementioned cable yoke, in particular about cable roller axes, which can be aligned parallel to one another and transversely to the plane spanned by the two cable strands.

In this respect, the pulleys can be mounted at a fixed distance from each other on the carrier or cable yoke.

However, as an alternative to cable pulleys or deflection pulleys, the cable guide elements can also comprise sliding guides, for example in the form of sliding shoes or blocks made of a suitable material such as plastic.

If the cable guide elements are arranged on the outer sides of the cable strands facing away from each other in order to keep the cable strands close together, substantially only outwardly directed forces act on the cable guide elements, i. e. the cable strands attempt to push the cable guide elements apart, so that, if necessary, it is also possible to mount the cable guide elements on the cable yoke so that they can be moved or pivoted, the outward movement of which is limited by a stop. For example, the cable guide elements, in particular the pulley rotation axes, can be accommodated in a sliding guide such as a longitudinal groove and pressed against a stop that specifies the position of the cable guide elements and thus the desired strand distance.

If necessary, adjustable stops can be provided in order to be able to set different strand distances. Such a strand distance adjustment device on the strand-distance guide can be advantageous in order to be able to use and adjust the strand distance guide for different bottom blocks.

Irrespective of the cable guide elements, which are arranged on the outer sides of the cable strands to be guided that face away from each other, the strand-distance guide, in particular the cable yoke, can also have cable guide elements that are arranged between the cable strands to be guided and face the inner sides of the cable strands that face each other in order to prevent the cable strands from coming too close to each other or having too small a strand distance. For example, two cable guide rollers or two sliding shoes can be arranged between the cable strands to push them apart if the cable strands want to come too close together. If sliding guide elements are used, a sliding shoe with two sliding guide surfaces facing away from each other can also be provided if necessary and arranged between the cable strands.

In order to achieve a small strand distance at the bottom block, which makes it possible to work in confined surroundings such as shafts, the bottom block can be configured to have a single pulley and the hoist cable reeved around one deflection pulley can have a wrap angle around the deflection pulley of approximately 180°. With such a single-roller design of the bottom block, the strand distance of the hoist rope strands at the bottom block, more specifically at its entry and exit points, is essentially determined by the diameter of the deflection pulley. The strand distance corresponds substantially to the diameter of the deflection pulley.

If the hoist cable is reeved several times at the bottom block, several deflection pulleys can also be provided at the bottom block, wherein the several deflection pulleys are advantageously arranged coaxially to one another, wherein an axis offset in the vertical direction would also be possible, for example for assembly reasons.

If, for example, four cable strands run to the bottom block, two deflection pulleys can be provided on the bottom block, which can have coaxial pulley axes in order to achieve a small overall strand distance at the bottom block for the cable strands. In this respect, the strand distance corresponds substantially to the diameter-preferably the same diameter—of the deflection pulleys.

If such a deflection block with several coaxial deflection pulleys is used for four or more cable strands, the deflection pulley can be described as single-axis, as all deflection pulleys rotate around the same, jointly used pulley axis.

If the bottom block is configured to be single-roller and/or single-axis in the manner, the strand-distance guide with its cable guide elements can specify a strand distance which substantially corresponds to the diameter of the pulley or pulleys at the bottom block. In other words, the cable guide elements on the strand-distance guide can define a clear width that substantially corresponds to the diameter of the deflection pulley or pulleys at the bottom block, plus twice the cable diameter.

These and other objects, features and advantages of the present invention will become more apparent upon reading the following specification in conjunction with the accompanying drawing figures.

### BRIEF DESCRIPTION OF THE DRAWINGS

The accompanying Figures, which are incorporated in and constitute a part of this specification, illustrate several aspects described below.

FIG. 1 is a side view of a lifting gear in the form of a rotating tower crane, from whose jib a hoist cable descends, which carries a load hook as a load-bearing means via a bottom block.

FIG. 2 is a side view of the hoist cable between the tackle support at the jib of the crane configured as a trolley and the bottom block carrying the load hook, wherein a strand-distance guide according to an advantageous embodiment of the invention is arranged between the bottom block and the trolley, wherein the partial view FIG. 2(a) shows the trolley with the horizontal jib and the partial view FIG. 2(b) shows the trolley with the jib luffed up and the oscillating manner in which the strand-distance guide is suspended from the trolley is illustrated.

FIG. 3 is a side view of the hoist cable between the tackle support at the jib of the crane, configured as a trolley, and the bottom block carrying the load hook, wherein a strand-distance guide for tapering the strand distance at the tackle support is fitted directly to the tackle support between its deflection pulleys for the hoist cable.

FIG. 4 is a side view of the hoist cable between the tackle support at the jib of the crane, configured to act as a trolley, and the bottom block carrying the load hook, wherein a strand-distance guide is fitted to the tackle support, suspended a little way down, which tapers the strand distance of the hoist cable descending in two strands from the tackle support a little way below the tackle support.

FIG. 5 is a side view of the hoist cable between the tackle support at the jib of the crane and the bottom block carrying the load hook, similar to FIGS. 3 and 4, wherein the hoist cable has a V-shaped splayed course without a strand-distance guide between the bottom block and the tackle support.

FIG. 6 is a side view of the course of the hoisting cable between the trolley and the bottom block, wherein partial view FIG. 6(a) shows the course of the hoisting cable with a single-roller bottom block using the strand-distance guide, while partial view FIG. 6(b) shows the course of the hoisting cable with a single-roller bottom block without a strand-distance guide between the bottom block and the trolley, and partial view FIG. 6(c) shows the conventional course of the hoisting cable between a double-roller bottom block and the trolley.

### DETAIL DESCRIPTION OF THE INVENTION

To facilitate an understanding of the principles and features of the various embodiments of the invention, various illustrative embodiments are explained below. Although exemplary embodiments of the invention are explained in detail, it is to be understood that other embodiments are contemplated. Accordingly, it is not intended that the invention is limited in its scope to the details of construction and arrangement of components set forth in the following description or illustrated in the drawings. The invention is capable of other embodiments and of being practiced or carried out in various ways. Also, in describing the exemplary embodiments, specific terminology will be resorted to for the sake of clarity.

It must also be noted that, as used in the specification and the appended claims, the singular forms “a,” “an” and “the” include plural references unless the context clearly dictates otherwise. For example, reference to a component is intended also to include composition of a plurality of components. References to a composition containing “a” constituent is intended to include other constituents in addition to the one named.

Also, in describing the exemplary embodiments, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” or “substantially” one particular value and/or to “about” or “approximately” or “substantially” another particular value. When such a range is expressed, other exemplary embodiments include from the one particular value and/or to the other particular value.

Similarly, as used herein, “substantially free” of something, or “substantially pure”, and like characterizations, can include both being “at least substantially free” of something, or “at least substantially pure”, and being “completely free” of something, or “completely pure”.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a composition does not preclude the presence of additional components than those expressly identified.

The materials described as making up the various elements of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

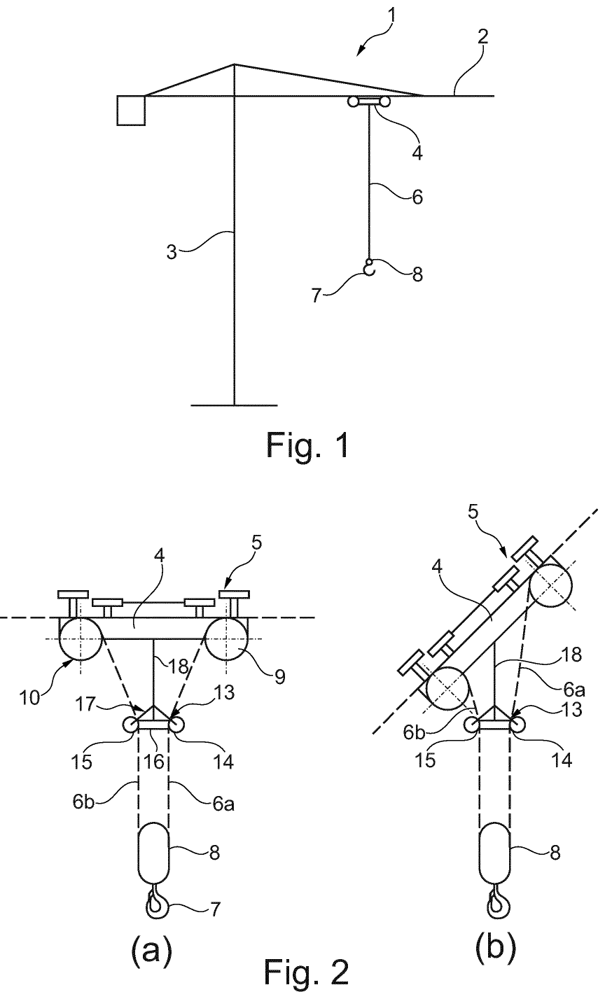

As FIG. 1 shows, the lifting gear 1 can, for example, be a crane in the form of a rotating tower crane, which has a jib 2 mounted on a tower 3. A trolley 4 can be moved along the jib 2 by a trolley drive, wherein the trolley 4 forms a tackle support 5, from which the hoist cable 6 descends and can be retracted and lowered by a hoisting gear comprising a cable winch, which can be arranged on the counter jib, for example, in order to be able to raise and lower a load-bearing means 7 in the form of a load hook, for example.

Depending on the crane type, the jib 2 can also be luffed in order to be brought into different steep positions. For example, the jib 2 can be luffed up and down by a luffing gear between different jib positions from, for example, a horizontal 0° to a 45° steep position, or possibly even steeper steep positions, wherein various intermediate positions can be set between the horizontal 0° position and the steep position. In this respect, the trolley 4 can also be moved with the jib set at a steeper angle, see for example FIG. 2(b).

In this respect, the load-bearing means 7 can be fastened to a bottom block 8, to which the hoist cable 6 is reeved, see FIGS. 2 to 6, so that two hoist cables 6a and 6b run from the tackle support 5 in the form of the trolley 4 to the bottom block 8. If necessary, the hoist cable 6 can also be reeved several times at the bottom block 8, so that four or six or more hoist cable strands can be provided between the tackle support and the bottom block, wherein an odd number of hoist cable strands can also be provided, if necessary, for example if the hoist cable 6 is attached with one end at the bottom block 8.

As FIGS. 2 to 6 show, the hoist cable 6 can be deflected at the trolley 4 by means of two deflection pulleys 9, 10 provided there, so that the hoist cable 6 extends from the trolley 4 to both ends of the jib 2, see FIG. 2, and the trolley 4 can be moved without the hoist cable 6 being elongated or shortened or the load-bearing means 7 being raised or lowered unintentionally.

In this respect, the pulleys 9 and 10 of the trolley 4 define the strand distance of the cable strands 6a and 6b directly at the tackle support 5.

As FIG. 6(a) shows, the bottom block 8 is advantageously configured to be single-roller or single-axis, so that the hoist cable 6 loops around the deflection pulley 12 provided at the bottom block 8 over a looping angle of approximately 180°. Due to the single-roller or single-axis design of the guide pulley 8, the diameter of the guide pulley 12 defines the strand distance 11 at the bottom block 8.

As FIG. 6 shows, the strand distance 11b at the trolley 4 can be significantly greater than the strand distance 11a at the bottom block 8, so that the cable strands 6a, 6b between the bottom block 8 and the trolley 4 would in themselves have a V-shaped spread, as shown in the partial view b of FIG. 6.

However, as FIG. 6(a) shows, this spreading out of the cable strands 6a and 6b in a V-shape manner can be limited to the area of the tackle support 5 or to only a smaller area of the lowering depth of the bottom block 8.

As FIG. 6(a) shows, a strand-distance guide 13 is provided between the bottom block 8 and the tackle support 5, which holds or guides the cable strands 6a, b of the hoist cable 6 at a desired strand distance 11 from one another, wherein the strand-distance guide 13 can be configured in particular to guide the cable strands 6a, b at a strand distance 11 which substantially corresponds to the strand distance 11a directly at the bottom block 8 and/or the diameter of the deflection pulley 12 of the bottom block 8.

In particular, the strand-distance guide 13 can hold the two cable strands 6a and 6b together and prevent them from running apart or prevent the cable strands 6a, b from moving apart beyond a predetermined distance. In particular, the strand-distance guide 13 can hold the cable strands 6a, b so close together that the cable strands 6a, b extend between the bottom block 8 and the strand-distance guide 13 at least approximately parallel to each other, see FIG. 6(a).

The strand-distance guide 13 may in particular comprise two cable guide elements 14, 15, which may be mounted on a support 16 and arranged spaced apart from one another.

For example, the cable guide elements 14, 15 can be configured to be cable pulleys that can roll on the cable strands 6a, b or guide the passing hoist cable 6. If the cable guide elements 14, 15 are configured to be cable pulleys, the cable pulleys may have parallel axes of rotation which are spaced apart from one another and may extend substantially perpendicular to the virtual plane spanned by the two cable strands 6a, b.

The cable guide elements 14, 15 and the support 16, on which the cable guide elements 14, 15 are mounted, together form a cable yoke 17 which can embrace the two cable strands 6a, b—viewed as a group—from at least three sides. In particular, the cable guide elements 14, 15 may be arranged on the outside of the two cable strands 6a, b facing away from each other in order to prevent the cable strands 6a, b from drifting too far apart.

The portions of the cable guide elements 14, 15 facing the cable strands 6a, b, in particular the surfaces of the cable guide elements 14, 15 that are in contact with the hoist cable 6, can have a distance between them and/or define a clear width between them that corresponds at least approximately to the strand distance 11a directly at the deflection pulley 12 and/or can correspond at least approximately to the diameter of the deflection pulley 12 of the bottom block 8 plus twice the cable diameter of the hoist cable 6.

The hoist cable 6 runs with its two strands of the hoist cable 6a, b between the cable guide elements 14, 15 and, apart from minor friction or rolling effects, does not experience any forces or any significant forces in the longitudinal direction of the cable on the cable guide elements 14, 15 and, in particular, no loads are transferred to the cable yoke 17.

As FIG. 2 shows, the cable yoke 17 can advantageously be suspended in an oscillating manner at the tackle support 5 or the trolley 4, for example by means of a flexible tension element 18 such as a chain or a rope or by an articulated suspension. The oscillating suspension 18 allows the strand-distance guide 13 to follow oscillating movements of the hoist cable or transverse movements of the hoist cable 6 and to align itself in relation to the trolley 4, for example when the jib 2 is luffed up, see FIG. 2(b).

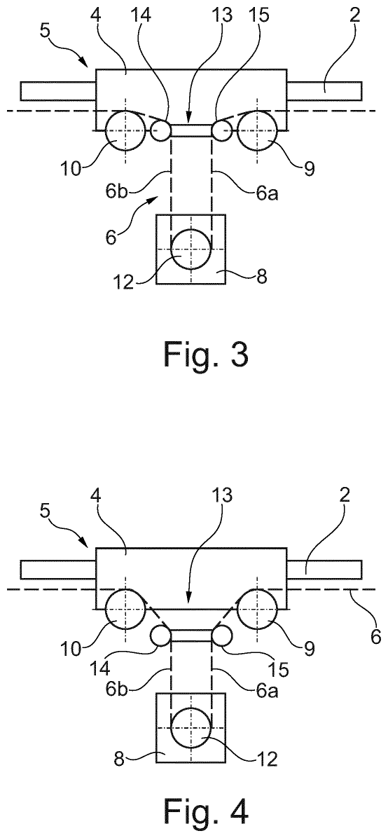

However, as FIG. 3 shows, the strand-distance guide 13 can also be arranged directly on the tackle support 5, wherein the strand-distance guide 13 can be rigidly mounted at the tackle support 5, so that the strand-distance guide 13 would follow the tilting of the tackle support when the jib 2 rocks up and down.

As FIG. 3 shows, the strand-distance guide 13 can, for example, comprise the two the cable guide elements 14 and 15, between which the lifting cable strands descending from the tackle support 5 are reduced in their strand distance, in particular approximately to the strand distance at the bottom block.

Irrespective of this, the strand-distance guide 13 can, for example, be arranged between the two deflection pulleys 9, 10 of the tackle support 5 and/or positioned approximately at the height of the two the cable deflection pulleys 9, 10 of the tackle support 5, so that the strand-distance guide 13 can guide the cable strands 6a, b in parallel substantially over the total lowering depth between the tackle support 5 and the bottom block 8.

However, as FIG. 4 shows, the strand-distance guide 13 can also be fitted suspended a little from the tackle support 5 and/or arranged a little below the tackle support 5, in particular a little below the deflection pulleys 9 and 10.

Advantageously, the strand-distance guide 13 can be detachably mounted on the tackle support 5, so that the tackle support 5 can optionally be operated with strand-distance guide 13 or also without strand-distance guide 13. If necessary, different strand-distance guides 13 can also be mounted at the tackle support or interchanged to define different strand distances.

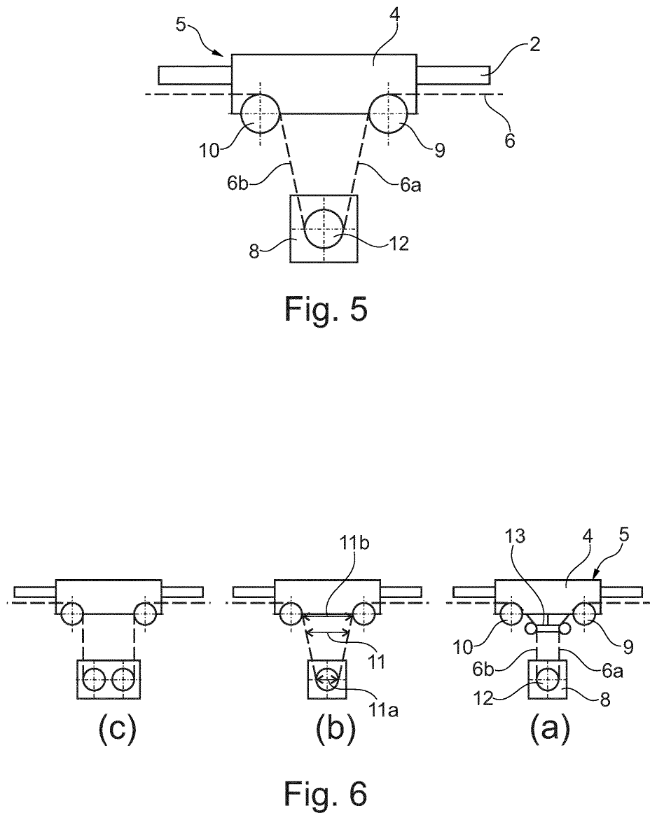

If the tackle support 5 is operated without a strand-distance guide 13, see FIG. 5, the hoist cable 6 or its cable strands 6a, b take(s) a substantially V-shaped, splayed course from the bottom block 8 to the tackle support 5. Depending on the lowering depth at the bottom block 8, the course is more or less wedge-shaped. If, for example, relatively large lowering depths are used, the V-shaped spread is relatively unobtrusive.

If the strand-distance guide 13 is rigidly fastened to the tackle support 5, for example in the position shown in FIG. 3, the strand-distance guide 13 can be fitted directly at the tackle support 5 in various ways, for example by bolting or screwing.

However, in many cases it is not necessary to arrange the strand-distance guide 13 at the level of the deflection pulleys 9, 10 of the tackle support 5, as shown in FIG. 3. It is often sufficient to guide the cable strands 6a, b parallel over a predominant part of the lowering depth or to keep them at the tapered strand distance at the bottom block 8, for example by fitting the strand-distance guide 13 slightly suspended, as shown in FIG. 4. By fitting the strand-distance guide 13 to the trolley or the tackle support 5 in a suspended position and swinging with the hoist rope strands, the distance between the hoist rope strands 6a, b is reduced in a similar way to the embodiment shown in FIG. 3 and substantially the same advantageous properties for a slim footprint are achieved. This advantage can be fully utilized over an only insignificantly restricted and thus over almost the total vertical travel path or the total lifting height. On the other hand, disadvantageous changes to the static system of the trolley can be avoided.

In particular, with an oscillating suspension of the strand-distance guide 13, the trolley operation and a still slim strand-distance guide can also be achieved with jibs luffed in various steep positions, see FIG. 2(b).

Numerous characteristics and advantages have been set forth in the foregoing description, together with details of structure and function. While the invention has been disclosed in several forms, it will be apparent to those skilled in the art that many modifications, additions, and deletions, especially in matters of shape, size, and arrangement of parts, can be made therein without departing from the spirit and scope of the invention and its equivalents as set forth in the following claims. Therefore, other modifications or embodiments as may be suggested by the teachings herein are particularly reserved as they fall within the breadth and scope of the claims here appended.

1. A lifting gear having comprising:
a hoist cable;
a tackle support;
a bottom block; and
a strand-distance guide;
wherein:
the hoist cable descends in at least two cable strands from the tackle support;
the bottom block is reeved on the hoist cable and on which a load-bearing means is fitted;
the cable strands of the hoist cable are at a different distance apart from one another at the bottom block than at the tackle support;
the strand-distance guide is between the bottom block and the tackle support and is configured for:
compensating for the different strand distances at the bottom block and at the tackle support; and
guiding the cable strands:
substantially parallel to one another on one side of the strand-distance guide; and
splayed apart in a V shape in relation to one another on the opposite side of the strand-distance guide.

2. The lifting gear according to claim 1, wherein the strand-distance guide is further configured to at least one of:
be reeving-free;
transmit to the hoist cable substantially only forces which are directed transversely to a virtual connecting line between the tackle support and the bottom block.

3. The lifting gear according to claim 1, wherein the strand-distance guide is suspended in an oscillating manner from the tackle support by means of a pendulum suspension.

4. The lifting gear according to claim 1, wherein:
the strand-distance guide is arranged in at least an upper quarter of a maximum lowering depth of the load-bearing means, which is measured from the tackle support to the load-bearing means.

5. The lifting gear according to claim 4, wherein the strand-distance guide has a distance from the tackle support that is less than 200% of the strand distance at the tackle support.

6. The lifting gear according to claim 1, wherein the strand-distance guide is rigidly fastened to the tackle support.

7. The lifting gear according to claim 1, wherein the strand-distance guide is detachably mounted on the tackle support between and/or at the level of two deflection pulleys of the tackle support for deflecting the hoist cable.

8. The lifting gear according to claim 1, wherein the strand-distance guide is further configured to maintain the cable strands at a strand distance from each other, from the strand-distance guide to the bottom block, which substantially corresponds to the strand distance at the bottom block.

9. The lifting gear according to claim 1, wherein the strand-distance guide has two cable guide elements spaced apart from one another, which are or can be brought into contact with sides of the cable strands running between the cable guide elements that face away from one another.

10. The lifting gear according to claim 2, wherein the cable guide elements define a clear width therebetween that substantially corresponds to at least one of:
the strand distance at the bottom block;
a diameter of a deflection pulley of the bottom block plus twice the hoist cable diameter.

11. The lifting gear according to claim 9, wherein the cable guide elements are configured to be cable pulleys having mutually parallel pulley rotation axes, which extend transversely to a virtual plane spanned by the cable strands.

12. The lifting gear according to claim 1, wherein the strand-distance guide comprises a cable yoke embracing the at least two cable strands from opposite outer sides for limiting and/or reducing the strand distance of the cable strands passing through the cable yoke to a strand distance that substantially corresponds to the strand distance at the bottom block.

13. The lifting gear according to claim 1, wherein the tackle support is configured as a trolley mounted so as to be movable along a jib of the lifting gear.

14. A lifting gear having comprising:
a hoist cable;
a trolly; and
a bottom block;
wherein:
the hoist cable descends in at least two cable strands from the trolley;
the bottom block is reeved on the hoist cable and on which a load-bearing means is fitted;
the cable strands of the hoist cable are at a different strand distance apart from one another at the bottom block than at the trolly such that the cable strands of the hoist cable between the bottom block and the tackle support run splayed apart in a V-shape.

15. The lifting gear according to claim 14, wherein a course of the V-shaped widens upwards from the bottom block to the tackle support.

16. The lifting gear according to claim 14, wherein the bottom block is configured to be single-axis and/or single-roll and has at least one deflection pulley for reeving the hoist cable, which is looped around by the hoist cable over a looping angle of approximately 180°.

17. The lifting gear according to claim 16, wherein the diameter of the deflection pulley defines the strand distance at the bottom block.

18. The lifting gear according to claim 14, wherein;
the trolly is provided on a jib which can be luffed up into different steep positions; and
the trolly defines different strand distances for the hoist cable descending in the cable strands, depending on the steep position of the jib.

19. The lifting gear according to claim 1, wherein the lifting gear is configured to be a crane selected from the group consisting of a rotating tower crane, a telescopic boom crane, and a port loading crane.

20. The lifting gear according to claim 4, wherein:
the tackle support is a trolley;
the strand-distance guide is arranged in at least an upper sixth of the maximum lowering depth of the load-bearing means; and
the strand-distance guide is arranged directly at or directly below the tackle support.

21. The lifting gear according to claim 20, wherein the strand-distance guide is arranged in an upper tenth of the maximum lowering depth of the load-bearing means.
